(19) United States
(12) Patent Application Publication
(10) Pub. No.: US 2021/0349362 A1
(43) Pub. Date: Nov. 11, 2021

(54) COLOR FILTER SUBSTRATE AND DISPLAY PANEL

(71) Applicant: WUHAN CHINA STAR OPTOELECTRONICS TECHNOLOGY CO., LTD., Wuhan, Hubei (CN)

(72) Inventors: Yaoli HUANG, Wuhan, Hubei (CN); Xinglong HE, Wuhan, Hubei (CN)

(21) Appl. No.: 16/316,204

(22) PCT Filed: Sep. 13, 2018
(86) PCT No.: PCT/CN2018/105424

§ 371 Date: Jan. 8, 2019

(30) Foreign Application Priority Data
Aug. 31, 2018 (CN) 201811007974.7

(51) Int. Cl. G02F 1/1362

(52) U.S. Cl. CPC G02F 1/136222; G06K 9/00221; G02F 1/136286

(57) ABSTRACT

A color filter substrate and a display panel are provided. The color filter substrate has a transparent substrate, filter patterns, black resists, photosensitive elements, thin film transistors, data lines, and scan lines. The filter patterns are disposed on the transparent substrate. The black resists are disposed on the transparent substrate and disposed between the filter patterns. The photosensitive elements are sandwiched between the black resists and the transparent substrate. Each of the thin film transistors has a source electrode, a drain electrode, and a gate electrode, and the source electrodes of the thin film transistors are electrically connected to the photosensitive elements. The data lines are electrically connected to the drain electrodes of the thin film transistors. The scan lines are electrically connected to the gate electrodes of the thin film transistors.

### FIELD OF DISCLOSURE

The present disclosure relates to displays, and more particularly to a color filter substrate and a display panel.

### BACKGROUND OF DISCLOSURE

With the development of technology, there are now commercially available mobile phones with face recognition capabilities. However, in conventional mobile phones, a face recognition sensor is placed in a notch formed by grooving a top of the screen, so that a full screen display cannot be achieved. Further, a design process of the screen notching is difficult and the yield is low, thereby increasing manufacturing cost of the screen.

Therefore, it is necessary to provide a color filter substrate and a display panel to solve the problems in the conventional technology.

### SUMMARY OF DISCLOSURE

In view of the above, the present disclosure provides a color filter substrate and a display panel to solve the problems that a full screen function and a face recognition function can not be balanced, and cost of high screen production can not be improved.

An object of the present disclosure is to provide a color filter substrate and a display panel, which can have a face recognition function without notching a screen, so that a full screen function and a face recognition function can be balanced, and cost of screen production can be decreased.

To achieve the above object of the present disclosure, an embodiment of the present disclosure provides a color filter substrate which comprises a transparent substrate, a plurality of filter patterns, a plurality of black resists, a plurality of photosensitive elements, a plurality of thin film transistors, a plurality of data lines, a plurality of scan lines, and a chip. The plurality of filter patterns are disposed on the transparent substrate and comprise at least one red filter pattern, at least one green filter pattern, and at least one blue filter pattern. The plurality of black resists are disposed on the transparent substrate and are disposed between the plurality of filter patterns. The plurality of photosensitive elements are sandwiched between the black resists and the transparent substrate. Each of the plurality of thin film transistors has a source electrode, a drain electrode, and a gate electrode, where the source electrodes of the plurality of thin film transistors are electrically connected to the plurality of photosensitive elements. The plurality of data lines are electrically connected to the plurality of drain electrodes of the plurality of thin film transistors. The plurality of scan lines are electrically connected to the plurality of gate electrodes of the plurality of thin film transistors. The chip is electrically connected to the plurality of data lines.

In one embodiment of the present disclosure, the plurality of photosensitive elements comprise a plurality of charge coupled devices or a plurality of complementary metal oxide semiconductor devices.

In one embodiment of the present disclosure, the plurality of photosensitive elements comprise a plurality of monochrome photosensitive elements, a plurality of multicolor photosensitive elements, or a plurality of infrared photosensitive elements.

Further, another embodiment of the present disclosure provides a color filter substrate, which comprises a transparent substrate, a plurality of filter patterns, a plurality of black resists, a plurality of photosensitive elements, a plurality of thin film transistors, a plurality of data lines, and a plurality of scan lines. The plurality of filter patterns are disposed on the transparent substrate. The plurality of black resists are disposed on the transparent substrate and are disposed between the plurality of filter patterns. The plurality of photosensitive elements are sandwiched between the black resists and the transparent substrate. Each of the plurality of thin film transistors has a source electrode, a drain electrode, and a gate electrode, where the source electrodes of the plurality of thin film transistors are electrically connected to the plurality of photosensitive elements. The plurality of data lines are electrically connected to the plurality of drain electrodes of the plurality of thin film transistors. The plurality of scan lines are electrically connected to the plurality of gate electrodes of the plurality of thin film transistors.

In one embodiment of the present disclosure, the plurality of filter patterns comprise at least one red filter pattern, at least one green filter pattern, and at least one blue filter pattern.

In one embodiment of the present disclosure, the plurality of photosensitive elements comprise a plurality of charge coupled devices or a plurality of complementary metal oxide semiconductor devices.

In one embodiment of the present disclosure, the plurality of photosensitive elements comprise a plurality of monochrome photosensitive elements, a plurality of multicolor photosensitive elements, or a plurality of infrared photosensitive elements.

In one embodiment of the present disclosure, the color filter substrate further comprises a chip. The chip is electrically connected to the plurality of data lines.

Further, a further embodiment of the present disclosure provides a display panel, which comprises an array substrate, a color filter substrate, and a liquid crystal layer. The color filter substrate comprises a transparent substrate, a plurality of filter patterns, a plurality of black resists, a plurality of photosensitive elements, a plurality of thin film transistors, a plurality of data lines, and a plurality of scan lines. The plurality of filter patterns are disposed on the transparent substrate. The plurality of black resists are disposed on the transparent substrate and are disposed between the plurality of filter patterns. The plurality of photosensitive elements are sandwiched between the black resists and the transparent substrate. Each of the plurality of thin film transistors has a source electrode, a drain electrode, and a gate electrode, where the source electrodes of the plurality of thin film transistors are electrically connected to the plurality of photosensitive elements. The plurality of data lines are electrically connected to the plurality of drain electrodes of the plurality of thin film transistors. The plurality of scan lines are electrically connected to the plurality of gate electrodes of the plurality of thin film transistors. The liquid crystal layer is disposed between the array substrate and the color filter substrate.

In one embodiment of the present disclosure, the plurality of filter patterns comprise at least one red filter pattern, at least one green filter pattern, and at least one blue filter pattern.

In one embodiment of the present disclosure, the plurality of photosensitive elements comprise a plurality of charge coupled devices or a plurality of complementary metal oxide semiconductor devices.

In one embodiment of the present disclosure, the plurality of photosensitive elements comprise a plurality of monochrome photosensitive elements, a plurality of multicolor photosensitive elements, or a plurality of infrared photosensitive elements.

In one embodiment of the present disclosure, the color filter substrate further comprises a chip. The chip is electrically connected to the plurality of data lines.

Compared with the conventional technologies, the color filter substrate and the display panel including the same in one embodiment of the present disclosure can have a face recognition function without notching a screen by disposing a plurality of photosensitive elements between the black resists and the transparent substrate for face recognition. Therefore, a full screen function and a face recognition function can be balanced, and cost of screen production can be decreased.

To make the above description of the present disclosure more clearly comprehensible, it is described in detail below in examples of preferred embodiments with the accompanying drawings.

### DESCRIPTION OF DRAWINGS

FIG. 1A is a top view of a color filter substrate according to an embodiment of the present disclosure.

FIG. 1B is a top view of a portion of a color filter substrate according to an embodiment of the present disclosure.

FIG. 1C is a cross-sectional diagram of a portion of a color filter substrate according to an embodiment of the present disclosure.

FIG. 2 is a cross-sectional diagram of a display panel according to an embodiment of the present disclosure.

### DETAILED DESCRIPTION OF PREFERRED EMBODIMENTS

The following description of the embodiments with reference to the appended drawings is used for illustrating specific embodiments which may be used for carrying out the present disclosure. Furthermore, the directional terms described by the present disclosure, such as upper, lower, top, bottom, front, back, left, right, inner, outer, side, around, center, horizontal, lateral, vertical, longitudinal, axial, radial, uppermost or lowermost, etc., are only directions by referring to the accompanying drawings. Thus, the used directional terms are used to describe and understand the present disclosure, but the present disclosure is not limited.

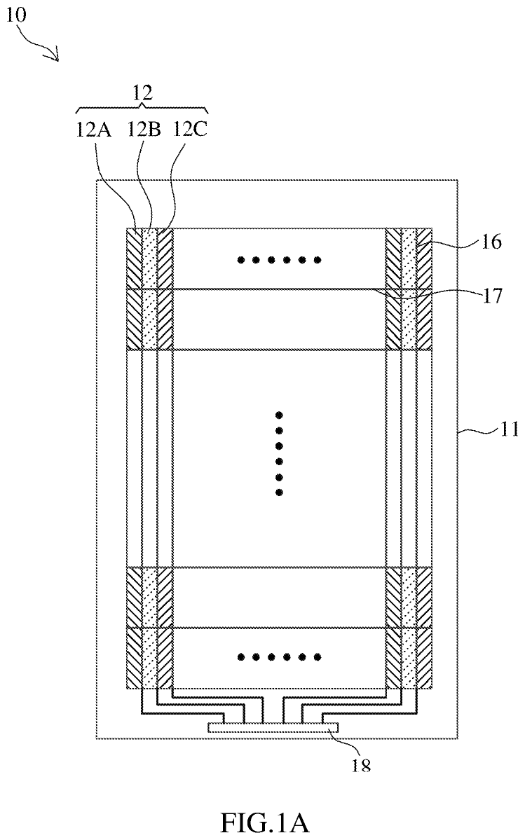

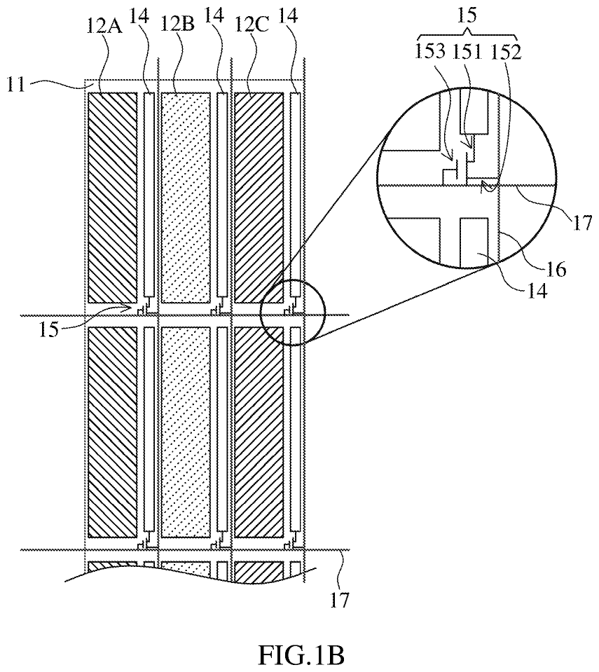

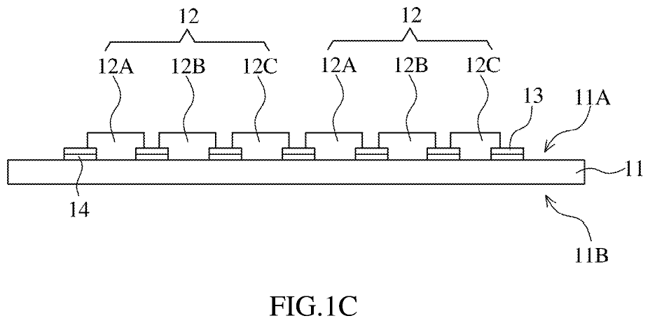

Referring to FIGS. 1A to 1C, FIG. 1A is a top view of a color filter substrate 10 according to an embodiment of the present disclosure, FIG. 1B is a top view of a portion of a color filter substrate 10 according to an embodiment of the present disclosure, and FIG. 1C is a cross-sectional diagram of a portion of a color filter substrate according to an embodiment of the present disclosure. For purposes of illustration, the black resist 13 is not shown in FIG. 1B so as to expose photosensitive elements 14. In one embodiment of the present disclosure, a color filter substrate 10 mainly includes a transparent substrate 11, a plurality of filter patterns 12, a plurality of black resists 13, a plurality of photosensitive elements 14, a plurality of thin film transistors 15, a plurality of data lines 16, and a plurality of scan lines 17. The transparent substrate is, for example, a base substrate having an inner surface 11A and an outer surface 11B opposite to each other, where the inner surface 11A can be used to support the plurality of filter patterns 12, the plurality of black resists. 13, the plurality of photosensitive elements 14, the plurality of thin film transistors 15, the plurality of data lines 16, and the plurality of scan lines 17. The outer surface 11B faces an external environment or faces a user's face. In one embodiment, the transparent substrate 11 is, for example, a glass substrate or a plastic substrate.

In one embodiment of the present disclosure, the plurality of filter patterns 12 of the color filter substrate 10 are disposed on the transparent substrate 11. In one embodiment, the plurality of filter patterns 12 comprise at least one red filter pattern 12A, at least one green filter pattern 12B, and at least one blue filter pattern 12C. In an example, a red filter pattern 12A, a green filter pattern 12B, and a blue filter pattern 12C form a filter pattern group, and a position of the filter pattern group can correspond to a position of a pixel unit located on the array substrate.

In one embodiment of the present disclosure, the plurality of black resists 13 of the color filter substrate 10 are disposed on the transparent substrate 11 and disposed between the plurality of filter patterns 12. In one embodiment, using the inner surface 11A of the transparent substrate 11 as a horizontal plane, the plurality of black resists 13 are located between the plurality of filter patterns 12 in a horizontal direction parallel to the horizontal plane. For example, the plurality of black resists 13 can form a matrix, and thus can also be referred to as a black matrix. The plurality of black resists 13 are mainly used to prevent color mixing when a light passes through the plurality of filter patterns 11 so as to reduce color vividness and saturation. Therefore, the plurality of black photoresists 13 are used to separate the plurality of filter patterns 12 from each other.

In one embodiment of the present disclosure, the plurality of photosensitive elements 14 of the color filter substrate 10 are sandwiched between the black resists 13 and the transparent substrate 11. The plurality of photosensitive elements 14 can be used, for example, to convert the sensed light into an electronic signal. In one embodiment, using the inner surface 11A of the transparent substrate 11 as a horizontal plane, the plurality of photosensitive elements 14 are positioned between the plurality of black photoresists 13 and the transparent substrate 11 in a vertical direction perpendicular to the horizontal plane. In another embodiment, a sensing surface of each of the photosensitive elements 14 is toward the transparent substrate 11 and can be used to sense an external light emitted into the transparent substrate 11. In an example, when a face of a user faces the transparent substrate 11, the plurality of photosensitive elements 14 can sense the external light that is refracted from the face of the user and is emitted into the transparent substrate 11, so as to convert the light into an electronic signal associated with the user's face. It is noted here that since the plurality of photosensitive elements 14 are sandwiched between the plurality of black resists 13 and the transparent substrate 11, the plurality of photosensitive elements 14 do not receive light from a backlight source.

In one embodiment, the plurality of photosensitive elements 14 comprise a plurality of charge coupled devices (CCD) or a plurality of complementary metal oxide semiconductor (CMOS) devices. In another embodiment, the plurality of photosensitive elements 14 comprise a plurality of monochrome photosensitive elements, a plurality of multicolor photosensitive elements, or a plurality of infrared photosensitive elements. In an example, a monochrome photosensitive element can identify a black and white image, and the multicolor photosensitive element can identify a color image. In another example, the infrared light sensing element can be performed without an external light source, for example, facial recognition can be performed in the evening without light.

In one embodiment of the present disclosure, each of the plurality of thin film transistors 15 of the color filter substrate 10 has a source electrode 151, a drain electrode 152, and a gate electrode 153, where the source electrodes 151 of the plurality of thin film transistors 15 are electrically connected to the plurality of photosensitive elements 14. In one embodiment, the plurality of thin film transistors 15 are mainly used as switches for controlling whether the electronic signals input from the source electrode 151 are transmitted to the drain electrode 152 by controlling the gate electrode 153.

In one embodiment of the present disclosure, the plurality of data lines 16 of the color filter substrate 10 are electrically connected to the plurality of drain electrodes 152 of the plurality of thin film transistors 15. The plurality of data lines 16 can retransmit the electronic signals, which are transmitted to the drain 152, to other locations. For example, the color filter substrate 10 can include a chip 18 electrically connected to the plurality of data lines 16. The electronic signal can be transmitted to the chip 18 through the plurality of data lines 16, and the chip 18 can convert the electronic signal into a display image so as to revert the measured light detected by the plurality of photosensitive elements 14. In one embodiment, the display image can be, for example, a face image.

In one embodiment of the present disclosure, the plurality of scan lines 17 of the color filter substrate are electrically connected to the plurality of gate electrodes 153 of the plurality of thin film transistors 15. The plurality of scan lines 17 are used to control the plurality of gate electrodes 153 of the plurality of thin film transistors 15. In one embodiment, the plurality of scan lines 17 can control the turning on or off of the plurality of thin film transistors 15 to determine whether to transmit an electronic signal at the source electrode 151 to the drain electrode 152 or not, for the chip 18 receiving the electronic signal through the data lines 16. In another embodiment, the plurality of scan lines 17 and the plurality of data lines 16 are perpendicular to each other and are not electrically contacted with each other.

In one embodiment, the color filter substrate 10 performs a face recognition in ways of, for example, sequentially inputting a high voltage (for example, 6 to 12 volts) to one of the plurality of scan lines 17 so as to sequentially turn on a corresponding thin film transistor 15, and a low voltage (for example, −9 to −7 volts) are input into the remaining scan lines 17, so as to turn off the remaining thin film transistors 15, thereby sequentially outputting the electronic signal to the chip 18 for generating a display image. In one embodiment, a pre-captured image (for example, a face image of a user) can be provided to the chip 18, and the chip 18 is used to compare whether the display image matches the preset image so as to generate a face recognition function.

In one embodiment, besides the face recognition function, the color filter substrate 10 of the embodiment of the present disclosure can also be actually used as a front camera of the display panel by the sensing of the plurality of photosensitive elements 14, and thus has the function of capturing images or videos. It is noted that the pre-captured image described above can be captured by the plurality of photosensitive elements 14.

In one embodiment of the present disclosure, each member of the color filter substrate 10, for example, a plurality of filter patterns 12, a plurality of black resists 13, a plurality of photosensitive elements 14, a plurality of thin film transistors 15, a plurality of data lines 16, a plurality of scanning lines 17, and the like, can be fabricated using a semiconductor process. Therefore, the production cost can be reduced due to no need to purchase additional new semiconductor equipment.

As described above, the color filter substrate 10 in one embodiment of the present disclosure can have a face recognition function without notching a screen by disposing a plurality of photosensitive elements 14 between the black resists 13 and the transparent substrate 11 for face recognition. Therefore, a full screen function and a face recognition function can be balanced, and cost of screen production can be decreased.

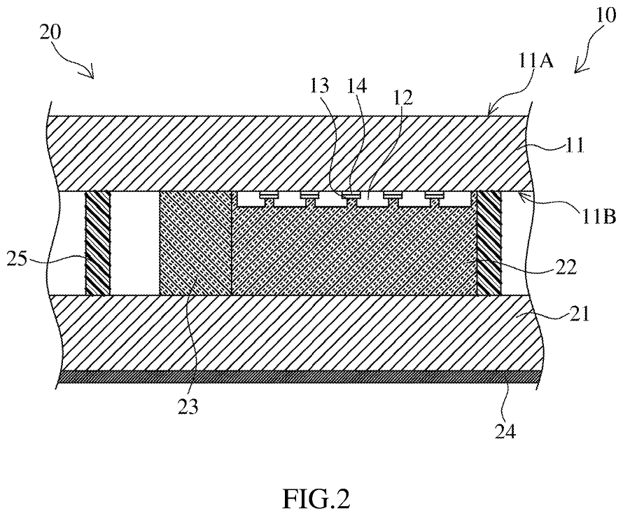

Referring to FIGS. 1A to 1C and FIG. 2, FIG. 2 is a cross-sectional diagram of a display panel according to an embodiment of the present disclosure. Another embodiment of the present disclosure provides a display panel 20, which comprises an array substrate 21, a color filter substrate 10, and a liquid crystal layer 22. The color filter substrate 10 comprises a transparent substrate 11, a plurality of filter patterns 12, a plurality of black resists 13, a plurality of photosensitive elements 14, a plurality of thin film transistors 15, a plurality of data lines 16, and a plurality of scan lines 17. The plurality of filter patterns 12 are disposed on the transparent substrate 11. The plurality of black resists 13 are disposed on the transparent substrate 11 and are disposed between the plurality of filter patterns 12. The plurality of photosensitive elements 14 are sandwiched between the black resists 13 and the transparent substrate 11. Each of the plurality of thin film transistors 15 has a source electrode 151, a drain electrode 152, and a gate electrode 153, where the source electrodes 151 of the plurality of thin film transistors 15 are electrically connected to the plurality of photosensitive elements 14. The plurality of data lines 16 are electrically connected to the plurality of drain electrodes 152 of the plurality of thin film transistors 15. The plurality of scan lines 17 are electrically connected to the plurality of gate electrodes 153 of the plurality of thin film transistors 15. The liquid crystal layer 22 is disposed between the array substrate 21 and the color filter substrate 10. The color filter substrate 10 of the display panel 20 can adopt the color filter substrate 10 of embodiments of the present disclosure described above, and thus the related embodiments and examples are not repeatedly described. In one embodiment, the display panel 20 can include a spacer 23 interposed between the color filter substrate 10 and the array substrate 21 to enable the spacer 23 received in a space formed by the spacer 23, the color filter substrate 10, and the array substrate 21.

In one embodiment, the array substrate 21 can have a plurality of device layers, for example, including a plurality of thin film transistors, a plurality of data lines, a plurality of scan lines, and the like. The plurality of device layers can be used to control steering of liquid crystal molecules of the liquid crystal layer to control whether the light of the backlight source 24 is directed toward the color filter substrate 10. In another embodiment, the array substrate 21 can be a commercially available array substrate.

In one embodiment, the array substrate 21 and the color filter substrate 10 can be bonded by a sealant 25 to enclose the liquid crystal layer 22 in a space formed by the array substrate 21, the color filter substrate 10, and the sealant 25.

In the panel display 20 in one embodiment of the present disclosure, the color filter substrate 10 can have a face recognition function without notching a screen by disposing a plurality of photosensitive elements 14 between the black resists 13 and the transparent substrate 11 for face recognition. Therefore, a full screen function and a face recognition function can be balanced, and cost of screen production can be decreased.

The present disclosure has been described in relative embodiments described above. However, the above embodiments are merely examples of performing the present disclosure. It must be noted that the implementation of the disclosed embodiments does not limit the scope of the disclosure. On the contrary, modifications and equal settings included in the spirit and scope of the claims are all included in the scope of the present disclosure.

1. A color filter substrate, comprising:
a transparent substrate;
a plurality of filter patterns disposed on the transparent substrate and comprising at least one red filter pattern, at least one green filter pattern, and at least one blue filter pattern;
a plurality of black resists disposed on the transparent substrate and disposed between the plurality of filter patterns;
a plurality of photosensitive elements sandwiched between the black resists and the transparent substrate;
a plurality of thin film transistors, each of the plurality of thin film transistors having a source electrode, a drain electrode, and a gate electrode, wherein the source electrodes of the plurality of thin film transistors are electrically connected to the plurality of photosensitive elements;
a plurality of data lines electrically connected to the plurality of drain electrodes of the plurality of thin film transistors;
a plurality of scan lines electrically connected to the plurality of gate electrodes of the plurality of thin film transistors; and
a chip electrically connected to the plurality of data lines.

2. The color filter substrate according to claim 1, wherein the plurality of photosensitive elements comprise a plurality of charge coupled devices or a plurality of complementary metal oxide semiconductor devices.

3. The color filter substrate according to claim 1, wherein the plurality of photosensitive elements comprise a plurality of monochrome photosensitive elements, a plurality of multicolor photosensitive elements, or a plurality of infrared photosensitive elements.

4. A color filter substrate, comprising:
a transparent substrate;
a plurality of filter patterns disposed on the transparent substrate;
a plurality of black resists disposed on the transparent substrate and disposed between the plurality of filter patterns;
a plurality of photosensitive elements sandwiched between the black resists and the transparent substrate;
a plurality of thin film transistors, each of the plurality of thin film transistors having a source electrode, a drain electrode, and a gate electrode, wherein the source electrodes of the plurality of thin film transistors are electrically connected to the plurality of photosensitive elements;
a plurality of data lines electrically connected to the plurality of drain electrodes of the plurality of thin film transistors; and
a plurality of scan lines electrically connected to the plurality of gate electrodes of the plurality of thin film transistors.

5. The color filter substrate according to claim 4, wherein the plurality of filter patterns comprise at least one red filter pattern, at least one green filter pattern, and at least one blue filter pattern.

6. The color filter substrate according to claim 4, wherein the plurality of photosensitive elements comprise a plurality of charge coupled devices or a plurality of complementary metal oxide semiconductor devices.

7. The color filter substrate according to claim 4, wherein the plurality of photosensitive elements comprise a plurality of monochrome photosensitive elements, a plurality of multicolor photosensitive elements, or a plurality of infrared photosensitive elements.

8. The color filter substrate according to claim 4, further comprising a chip electrically connected to the plurality of data lines.

9. A display panel, comprising:
an array substrate;
a color filter substrate, comprising:
a transparent substrate;
a plurality of filter patterns disposed on the transparent substrate;
a plurality of black resists disposed on the transparent substrate and disposed between the plurality of filter patterns;
a plurality of photosensitive elements sandwiched between the black resists and the transparent substrate;
a plurality of thin film transistors, each of the plurality of thin film transistors having a source electrode, a drain electrode, and a gate electrode, wherein the source electrodes of the plurality of thin film transistors are electrically connected to the plurality of photosensitive elements;
a plurality of data lines electrically connected to the plurality of drain electrodes of the plurality of thin film transistors; and
a plurality of scan lines electrically connected to the plurality of gate electrodes of the plurality of thin film transistors; and
a liquid crystal layer disposed between the array substrate and the color filter substrate.

10. The display panel according to claim 9, wherein the plurality of filter patterns comprise at least one red filter pattern, at least one green filter pattern, and at least one blue filter pattern

11. The display panel according to claim 9, wherein the plurality of photosensitive elements comprise a plurality of charge coupled devices or a plurality of complementary metal oxide semiconductor devices.

12. The display panel according to claim 9, wherein the plurality of photosensitive elements comprise a plurality of monochrome photosensitive elements, a plurality of multicolor photosensitive elements, or a plurality of infrared photosensitive elements.

13. The display panel according to claim 9, wherein the color filter substrate further comprises a chip, wherein the chip is electrically connected to the plurality of data lines.
